(19) United States
(12) Patent Application Publication
(10) Pub. No.: US 2013/0181964 A1
(43) Pub. Date: Jul. 18, 2013

(54) LIQUID CRYSTAL DISPLAY

(71) Applicants: Cheng-Che Tsai, Tainan City (TW); Yu-Chu Yang, Tainan City (TW); Jen-Chang Hsiao, Tainan City (TW); Pu-Jen Cheng, Tainan City (TW)

(72) Inventors: Cheng-Che Tsai, Tainan City (TW); Yu-Chu Yang, Tainan City (TW); Jen-Chang Hsiao, Tainan City (TW); Pu-Jen Cheng, Tainan City (TW)

(73) Assignee: HIMAX TECHNOLOGIES LIMITED, Tainan City (TW)

(21) Appl. No.: 13/349,354

(22) Filed: Jan. 12, 2012

(51) Int. Cl. G09G 5/00; G09G 3/36

(52) U.S. Cl. 345/211; 345/87

(57) ABSTRACT

A liquid crystal display (LCD) including a LCD panel having a plurality of pixels, a source driver outputting a plurality of pixel voltages to the LCD panel, a gate driver, and a timing controller is provided. During performing a polarity inversion on a polarity signal corresponding to a first frame, the timing controller sequentially outputs a first start signal and a second start signal to the gate driver in a first frame period corresponding to the first frame. The gate driver sequentially outputs a plurality of first scan signals and a plurality of second scan signals to the LCD panel according to the first start signal and the second start signal, so that the brightness corresponding to a plurality of gray levels in the first frame are equal to the brightness corresponding to the gray levels in a plurality of previous frames and a plurality of following frames.

### BACKGROUND OF THE INVENTION

1. Field of the Invention

The invention generally relates to a display, and more particularly, to a liquid crystal display.

2. Description of Related Art

With the advancing of the electro-optical technology and the semiconductor technology, flat display such as a Liquid Crystal Display (LCD) is flourishing developed recently. The LCD has become the mainstream in the market of the flat display because of its characteristics, such as high space utilization, low power consumption, no radiation and low electromagnetic disturbance. The LCD panel is not equipped with a function of light emission, and therefore a backlight module behind the LCD panel is required for supplying a planar light source to the LCD panel. The LCD panel displays images by adjusting light transmittance and light reflectivity through the control of the twisting angles of liquid crystal molecules.

Generally, the twisting angles of the liquid crystal molecules are determined by the voltage difference and the direction of the electric field between two sides of the liquid crystal layer. For preventing from the polarization of the liquid crystal molecules, the LCD adopts a polarity inversion driving method; that is, the liquid crystal molecules are alternately driven by the voltages having different polarities such as positive polarity and negative polarity in different periods. In such driving method, the polarity of the voltage applied to the liquid crystal molecules is determined by the direction of the electric field applied to liquid crystal molecules. The liquid crystal molecules are driven by the voltage with the positive polarity if the voltage of the pixel electrode is greater than the common voltage and on the contrary, the liquid crystal molecules are driven by the voltage with the negative polarity.

The gray levels presented on each pixel of the LCD panel may keep changing when the LCD panel displays dynamic images. Under the changing of the gray levels, the liquid crystal molecules of the LCD can still be polarized. Namely, the liquid crystal molecules on the pixel can have the residual DC voltage so that residual images are presented on the LCD panel.

For precluding the polarization of the liquid crystal molecules caused by the dynamic displaying of the LCD panel, the polarity signal of a specific frame can be inverted for rendering the polarity signal of the specific frame being identical to the polarity signal of the previous frame. Each of the pixels can be charged in the same polarity when the specific frame is written into the LCD panel, so that the brightness of each gray level in the specific frame is greater than the brightness of the gray level in the neighboring frames, which causes the image flick effect.

### SUMMARY OF THE INVENTION

The invention provides a LCD capable of rendering the brightness of a plurality of gray levels in the frame being subjected to the polarity inversion identical to the brightness of the gray levels in other frames so as to prevent from the image flick effect.

The invention directs to a liquid crystal display including a liquid crystal display panel, a source driver, a gate driver and a timing controller. The liquid crystal display panel has a plurality of pixels. The source driver is coupled to the liquid crystal display panel for outputting a plurality of pixel voltages to the liquid crystal display panel. The gate driver is coupled to the liquid crystal display panel. The timing controller is coupled to the source driver and the gate driver for performing a polarity inversion on the polarity signal outputted to the source driver. When the timing controller performs the polarity inversion on the polarity signal corresponding to a first frame, the timing controller sequentially outputs a first start signal and a second start signal to the gate driver in at least a first frame period corresponding to the first frame. The gate driver sequentially outputs a plurality of first scan signals and a plurality of second scan signals to the liquid crystal display panel according to the first start signal and the second start signal, such that the brightness corresponding to a plurality of gray levels in the first frame is identical to the brightness corresponding to the gray levels in a plurality of previous frames and a plurality of following frames.

In one embodiment of the invention, the timing controller sequentially outputs the first start signal and the second start signal to the gate driver in the first frame period such that a polarity of the pixel voltage received by each of the pixels driven by the corresponding first scan signal is opposite to a polarity of the pixel voltage received by the each of the pixels driven by the corresponding second scan signal.

In one embodiment of the invention, the source driver generates the pixel voltages in a row inversion driving method, and the first start signal and the second start signal are outputted continuously or spaced by even numbers of horizontal scan periods.

In one embodiment of the invention, the source driver generates the pixel voltages in a 1+n row inversion driving method, wherein n is a positive integer greater than or equivalent to 2. Additionally, the first start signal and the second start signal are spaced by n−1+i×2n horizontal scan periods, wherein i is a positive integer greater than or equivalent to zero.

In one embodiment of the invention, the timing controller outputs the first start signal to the gate driver in a plurality of previous frame periods corresponding to the previous frames and a plurality of following frame periods corresponding to the following frames.

In one embodiment of the invention, the timing controller outputs the second start signal to the gate driver in a plurality of previous frame periods corresponding to the previous frames and a plurality of following frame periods corresponding to the following frames.

In one embodiment of the invention, the timing controller sequentially outputs the first start signal and the second start signal to the gate driver in a plurality of previous frame periods corresponding to the previous frames and a plurality of following frame periods corresponding to the following frames.

In one embodiment of the invention, the timing controller sequentially outputs the first start signal and the second start signal to the gate driver in the first frame period, a plurality of previous frame periods corresponding to the previous frames and a plurality of following frame period corresponding to the following frames, such that a polarity of the pixel voltage received by each of the pixels driven by the corresponding first scan signal is identical to a polarity of the pixel voltage received by the each of the pixels driven by the corresponding second scan signal.

In one embodiment of the invention, the source driver generates the pixel voltages in a row inversion driving method, and the first start signal and the second start signal are outputted continuously or spaced by odd numbers of horizontal scan periods.

In one embodiment of the invention, the source driver generates the pixel voltages in a 1+n row inversion driving method, and the first start signal and the second start signal are spaced by 2n−1+i×2n numbers of horizontal scan periods.

Based on the above, in the LCD according to the embodiments of the invention, the timing controller sequentially outputs the first start signal and the second start signal in the frame period corresponding to the first frame or the frame periods corresponding to the previous frames, the first frame, and the following frames, so that each pixel of the LCD panel can present the brightness corresponding to a plurality of gray levels in the first frame identical to the brightness corresponding to said gray levels in the previous frames or the following frames. Thereby, the image flick effect can be precluded.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view illustrating a system of a liquid crystal display according to one embodiment of the invention.

FIG. 2 is a schematic timing diagram of the polarity signal depicted in FIG. 1 according to one embodiment of the invention.

FIG. 3 is a schematic timing diagram of the start signal, the scan signal, and the polarity of the pixel voltage depicted in FIG. 1 according to the first embodiment of the invention.

FIG. 4 is a schematic timing diagram of the start signal, the scan signal, and the polarity of the pixel voltage depicted in FIG. 1 according to the second embodiment of the invention.

FIG. 5 is a schematic timing diagram of the start signal, the scan signal, and the polarity of the pixel voltage depicted in FIG. 1 according to the third embodiment of the invention.

FIG. 6 is a schematic timing diagram of the start signal, the scan signal, and the polarity of the pixel voltage depicted in FIG. 1 according to the fourth embodiment of the invention.

FIG. 7 is a schematic timing diagram of the start signal, the scan signal, and the polarity of the pixel voltage depicted in FIG. 1 according to the fifth embodiment of the invention.

FIG. 8 is a schematic timing diagram of the start signal, the scan signal, and the polarity of the pixel voltage depicted in FIG. 1 according to the sixth embodiment of the invention.

FIG. 9 is a schematic timing diagram of the start signal, the scan signal, and the polarity of the pixel voltage depicted in FIG. 1 according to the seventh embodiment of the invention.

FIG. 10 is a schematic timing diagram of the start signal, the scan signal, and the polarity of the pixel voltage depicted in FIG. 1 according to the eighth embodiment

### DESCRIPTION OF EMBODIMENTS

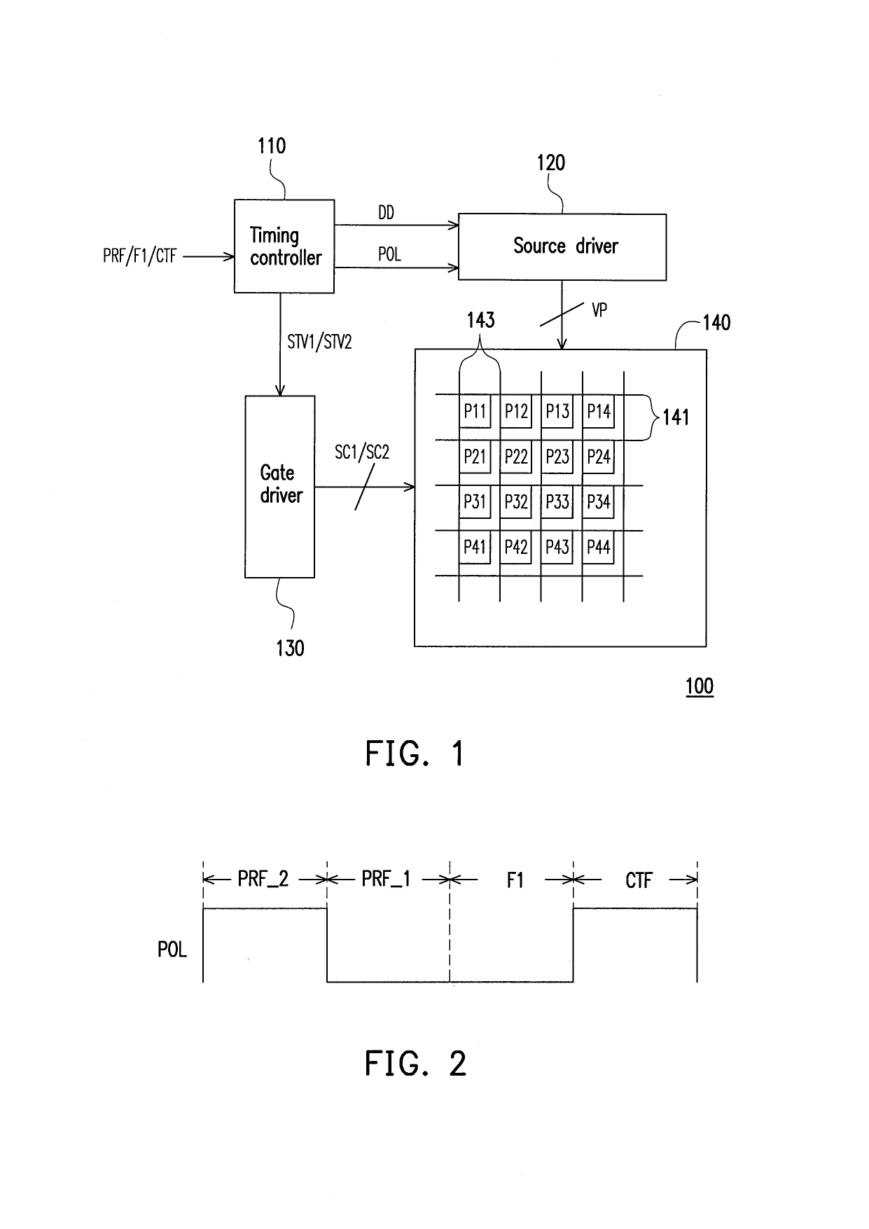

FIG. 1 is a schematic view illustrating a system of a liquid crystal display according to one embodiment of the invention. Referring to FIG. 1, in the present embodiment, an LCD 100 includes a timing controller 110, a gate driver 120, a source driver 130, and an LCD panel 140. The timing controller 110 is coupled to the gate driver 120 and the source driver 130. The gate driver 120 and the source driver 130 are respectively coupled to the LCD panel 140. The LCD panel 140 is configured with a plurality of scan lines 141, a plurality of data lines 143, and a plurality of pixels, such as P11˜P14, P21˜P24, P31˜P34, P41˜P44 . . . , etc., arranged in an array. Each of the pixels, such as P11˜P14, P21˜P24, P31˜P34, P41˜P44 . . . , etc., is coupled to the corresponding scan line 141 and the corresponding data line 143.

The timing controller 110 sequentially receives a plurality of previous frames PRF, a first frame F1, and a plurality of following frames CTF transmitted continuously and outputs a plurality of display data DD and a polarity signal POL to the source driver 130 according to the previous frames PRF, the first frame Fl, and the following frames CTF, so as to control the source driver 130 to output a plurality of pixel voltages VP to the data lines 143 of the LCD panel 140. In addition, the timing controller 110 can output a first start signal STV1 to the gate driver 120 for controlling the gate driver 120 to output a plurality of first scan signals SC1 to the scan lines 141 of the LCD panel 140 and output a second start signal STV2 to the gate driver 120 for controlling the gate driver 120 to output a plurality of second scan signals SC2 to the scan lines 141 of the LCD panel 140. The pixels, such as P11˜P14, P21˜P24, P31˜P34, P41˜P44 . . . , etc., of the LCD panel 140 driven by the corresponding first scan signals SC1 and /or the second scan signals SC2 receive the pixel voltages VP so that the images corresponding to the previous frames PRF, the first frame F1, and the following frames CTF are displayed.

FIG. 2 is a schematic timing diagram of the polarity signal depicted in FIG. 1 according to one embodiment of the invention. Referring to FIG. 1 and FIG. 2, according to the present embodiment, the timing controller 110 can perform a polarity inversion on the polarity signal POL with respect to the first frame F1 to reduce the probability that the liquid crystal molecules of the LCD panel 140 are polarized. In general, the polarity signal POL with respect to each frame is different to the polarity signal with respect to a next frame, i.e., the polarity signal POL corresponding to the previous frame PRF_2 is different to the polarity signal POL corresponding to the previous frame PRF_1, as well as the polarity signal POL corresponding to the first frame F1 is different to the polarity signal POL corresponding to the following frame CTF. When the timing controller 110 performs the polarity inversion on the polarity signal POL corresponding to the first frame F1, the polarity signal POL corresponding to the first frame F1 can be the same as the polarity signal POL corresponding to the previous frame (that is the previous frame PRF_1).

Now, the timing controller 110 sequentially outputs the first start signal STV1 and the second start signal STV2 to the gate driver 130 in at least the frame period corresponding to the first frame (i.e. the first frame period). The gate driver 130 can sequentially output the first scan signals SC1 and the second scan signals SC2 to the scan lines 141 of the LCD panel 140 according to the first start signal STV1 and the second start signal STV2, such that the brightness corresponding to a plurality of gray levels in the first frame F1 can be identical to the brightness corresponding to said gray levels in the previous frames PRF and the following frames CTF for preventing from the image flick effect.

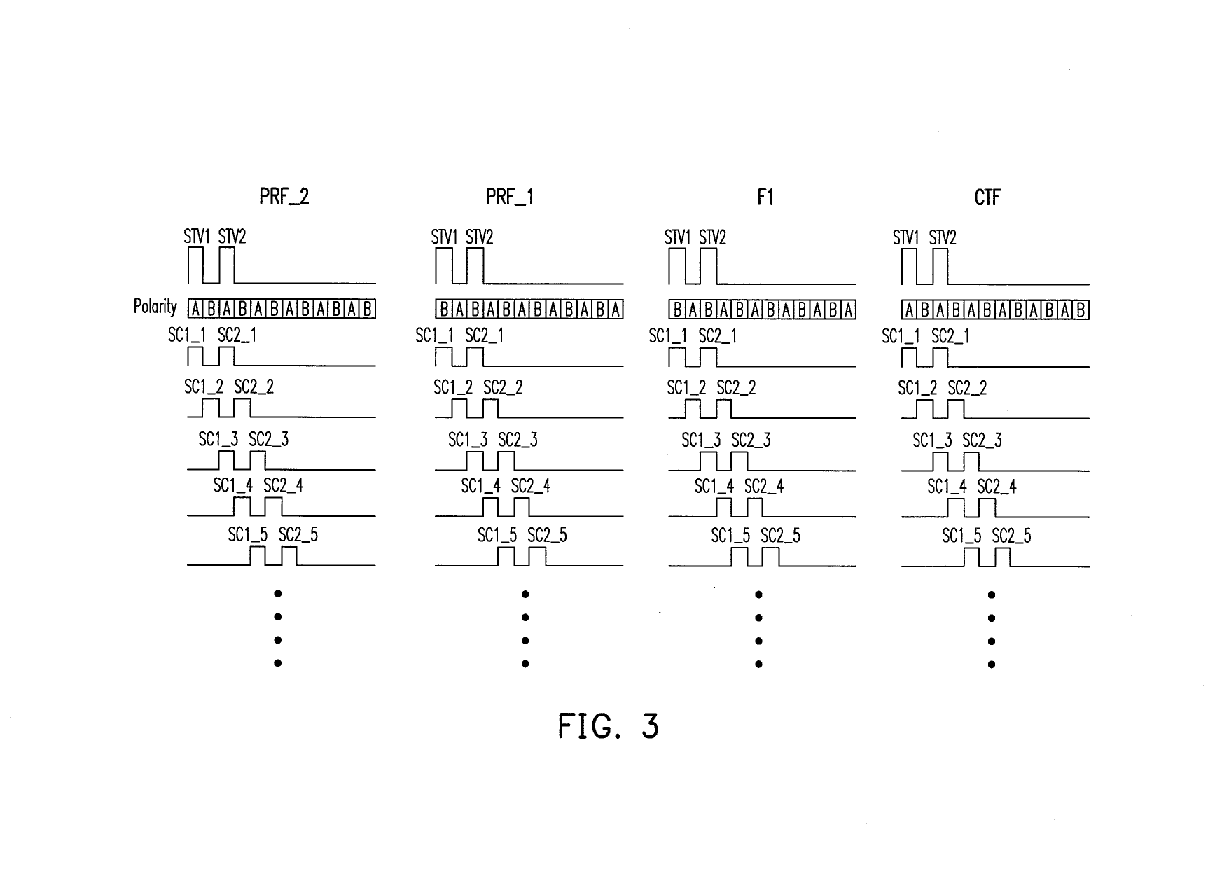

FIG. 3 is a schematic timing diagram of the start signal, the scan signal, and the polarity of the pixel voltage depicted in FIG. 1 according to the first embodiment of the invention. Referring to FIG. 1 through FIG. 3, in the present embodiment, it is assumed that the source driver 120 generates the pixel voltages VP in a row inversion driving method. Accordingly, the polarities of the pixel voltages VP outputted to the same data line 143 by the source driver 120 in different horizontal scan periods (corresponding to one pulse wavelength of the scan signal) can be alternately be the polarity A and the polarity B. Furthermore, the polarities of the pixel voltages VP are switched corresponding to the switching of the voltage level of the polarity signal POL. Herein, the polarity A and the polarity B can respectively be one of the positive polarity and the negative polarity. Namely, when the polarity A is the positive polarity, the polarity B is the negative polarity, or when the polarity A is the negative polarity, the polarity B is the positive polarity.

According to the present embodiment, in the frame periods corresponding to the previous frames PRF_2 and PRF_1, the first frame F1, and the following frames CTF (that is, the previous frame periods, the first frame period, and the following frame periods), the timing controller 110 can sequentially output the first start signal STV1 and the second start signal STV2 to the gate driver 130, wherein the first start signal STV1 and the second start signal STV2 are spaced by one horizontal scan period. Therefore, the first scan signals, such as SC1_1˜SC1_5, and the corresponding second scan signals, such as SC2_1˜SC2_5, outputted by the gate driver 130 are spaced by one horizontal scan period.

As shown in FIG. 3, the polarities of the pixel voltages VP (such as the polarity A) received by the pixels in the first row, such as P11˜P14, driven by the first scan signal SC1_1 in the LCD panel 140 are identical to the polarities of the pixel voltages VP (such as the polarity A) received by these pixels driven by the second scan signal SC2_1 in the same frame. The polarities of the pixel voltages VP (such as the polarity B) received by the pixels in the second row, such as P21˜P24, driven by the first scan signal SC1_2 in the LCD panel 140 are identical to the polarities of the pixel voltages VP (such as the polarity B) received by these pixels driven by the second scan signal SC2_2 in the same frame. The rest are all in a similar way.

According to the above descriptions, each pixel, such as P11˜P14, P21˜P24, P31˜P34, P41˜P44, etc., is charged in the same polarity in the frame periods corresponding to the previous frames PRF_2 and PRF_1, the first frame F1, and the following frames CTF so that the charge effect of each pixel, such as P11˜P14, P21˜P24, P31˜P34, P41˜P44, etc., is gradually saturated. In specific, each pixel, such as P11˜P14, P21˜P24, P31˜P34, P41˜P44, etc., is pre-charged by using a received pixel voltage VP under the driving of the first scan signal SC1 so that when the pixel receives another pixel voltage VP which is corresponding to the gray level to-be displayed under the driving of the second scan signal SC2, the voltage stored in each pixel, such as P11˜P14, P21˜P24, P31˜P34, P41˜P44, etc., can be roughly equivalent to the received another pixel voltage VP.

Therefore, the brightness presented in each pixel, such as P11˜P14, P21˜P24, P31˜P34, P41˜P44, etc., can be consistent when each pixel, such as P11˜P14, P21˜P24, P31˜P34, P41˜P44, etc., receives the pixel voltage VP corresponding to the same gray level in the frame periods corresponding to the previous frames PRF_2 and PRF_1, the first frame F1, and the following frames CTF, and thereby the image flick effect can be avoided.

In the foregoing embodiment, the first start signal STV1 and the second start signal STV2 are spaced by one horizontal scan period. In an alternate embodiment, each pixel, such as P11˜P14, P21˜P24, P31˜P34, P41˜P44, etc., can be charged in the same polarity by using the received pixel voltage VP under the driving of the first scan signal SC1 and the received pixel voltage VP under the driving of the second scan signal SC2 when the first start signal STV1 and the second start signal STV2 are spaced by odd numbers (e.g. 1, 3, 5 . . . ) of the horizontal scan periods.

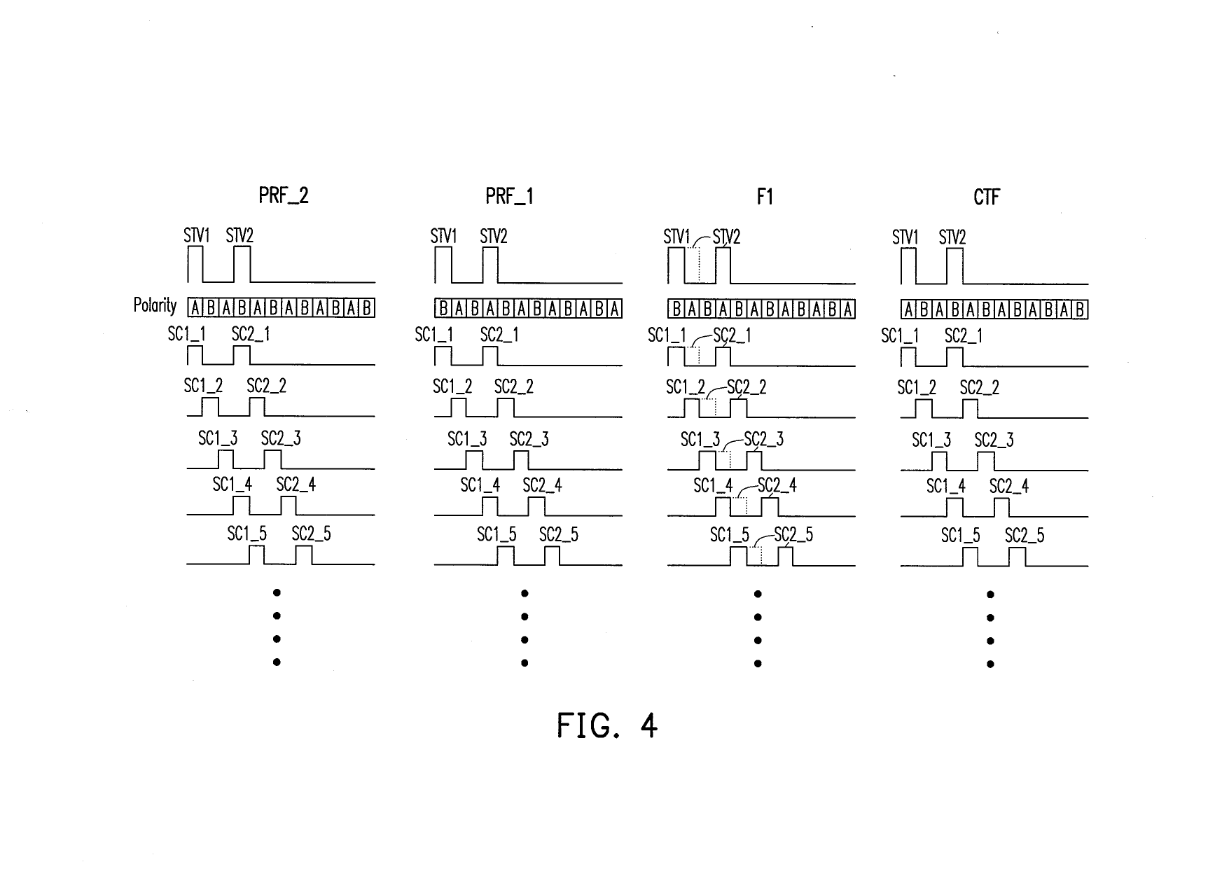

FIG. 4 is a schematic timing diagram of the start signal, the scan signal, and the polarity of the pixel voltage depicted in FIG. 1 according to the second embodiment of the invention. Referring to FIG. 1 through FIG. 4, in the present embodiment, the source driver 120 similarly is assumed to generate the pixel voltages VP in a row inversion driving method. Herein, in the frame periods corresponding to the previous frames PRF_2 and PRF_1, the first frame F1, and the following frames CTF, the timing controller 110 can sequentially output the first start signal STV1 and the second start signal STV2 to the gate driver 130, wherein the first start signal STV1 and the second start signal STV2 are spaced by two horizontal scan periods. Therefore, the first scan signals, such as SC1_1˜SC1_5, and the corresponding second scan signals, such as SC2_1˜SC2_5, outputted by the gate driver 130 are spaced by two horizontal scan periods.

As shown in FIG. 4, the polarities of the pixel voltages VP (such as the polarity A) received by the pixels in the first row, such as P11˜P14, driven by the first scan signal SC1_1 in the LCD panel 140 are opposite to the polarities of the pixel voltages VP (such as the polarity B) received by these pixels driven by the second scan signal SC2_1 in the same frame. The polarities of the pixel voltages VP (such as the polarity B) received by the pixels in the second row, such as P21˜P24, driven by the first scan signal SC1_2 in the LCD panel 140 are opposite to the polarities of the pixel voltages VP (such as the polarity A) received by these pixels driven by the second scan signal SC2_2 in the same frame. The rest are all in a similar way.

According to the above descriptions, each pixel, such as P11˜P14, P21˜P24, P31˜P34, P41˜P44, etc., are charged in opposite polarities in the frame periods corresponding to the previous frames PRF_2 and PRF_1, the first frame F1, and the following frames CTF so that the charge effect of each pixel, such as P11˜P14, P21˜P24, P31˜P34, P41˜P44, etc., is consistent. In specific, each pixel, such as P11˜P14, P21˜P24, P31˜P34, P41˜P44, etc., is charged in opposite polarities by using a received pixel voltage VP under the driving of the first scan signal SC1 so that when the pixel receives another pixel voltage VP which is corresponding to the gray level to-be displayed under the driving of the second scan signal SC2, the voltage stored in each pixel, such as P11˜P14, P21˜P24, P31˜P34, P41˜P44, etc., can be substantially consistent if the same gray level is displayed.

Therefore, the brightness presented in each pixel, such as P11˜P14, P21˜P24, P31˜P34, P41˜P44, etc., can be consistent when each pixel, such as P11˜P14, P21˜P24, P31˜P34, P41˜P44, etc., receives the pixel voltage VP corresponding to the same gray level in the frame periods corresponding to the previous frames PRF_2 and PRF_1, the first frame F1, and the following frames CTF, and thereby the image flick effect can be avoided.

In the foregoing embodiment, the first start signal STV1 and the second start signal STV2 are spaced by two horizontal scan periods. In an alternate embodiment, each pixel, such as P11˜P14, P21˜P24, P31˜P34, P41˜P44, etc., can be charged in opposite polarities by using the received pixel voltage VP under the driving of the first scan signal SC1 and the received pixel voltage VP under the driving of the second scan signal SC2 when the first start signal STV1 and the second start signal STV2 are continuously outputted (referred to the second start signal STV2 shown by the dot line) or spaced by even numbers (e.g. 2, 4, 6 . . . ) of the horizontal scan periods. Herein, each of the second scan signals (referred to the second scan signals SC2_1˜SC2_5 shown by the dot line) follows the corresponding first scan signals (such as SC1_1˜SC1_5) when the first start signal STV1 and the second start signal STV2 are outputted continuously.

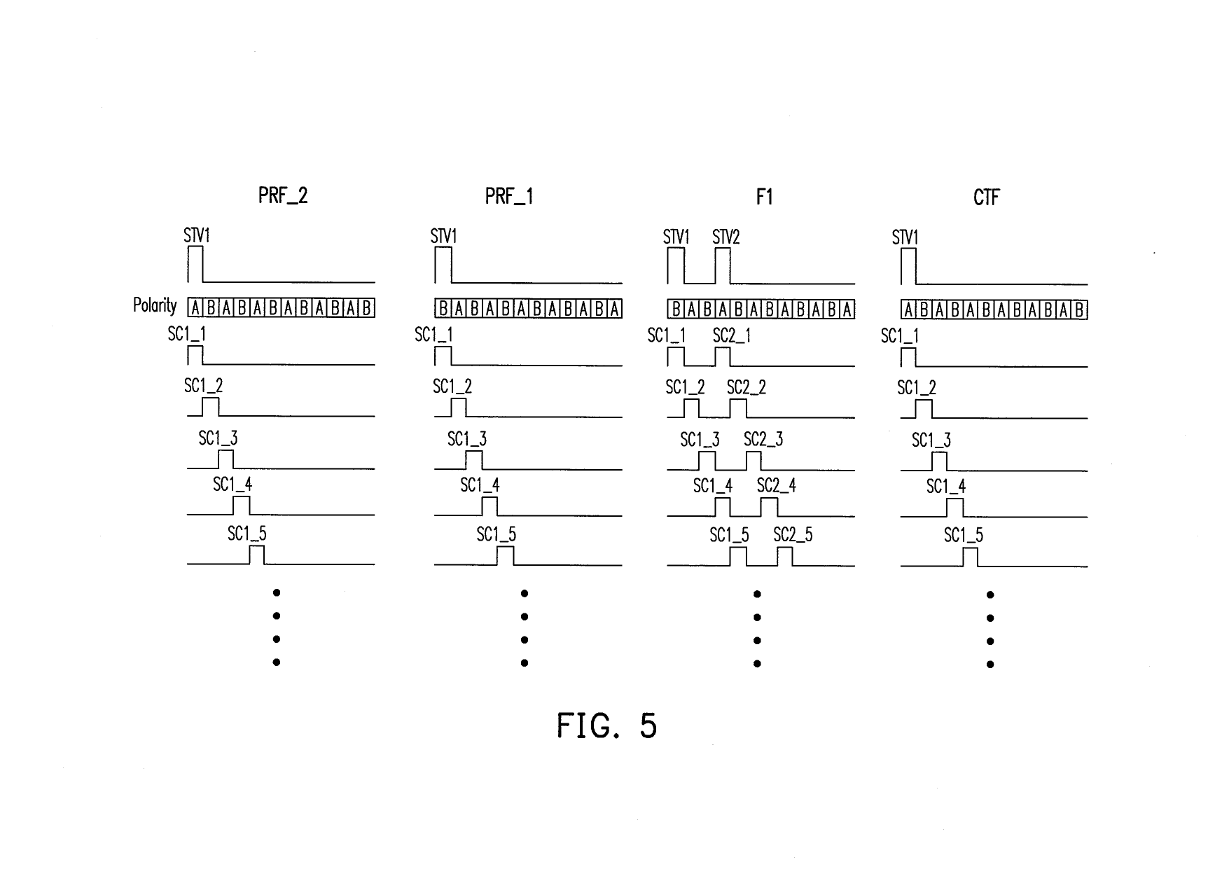

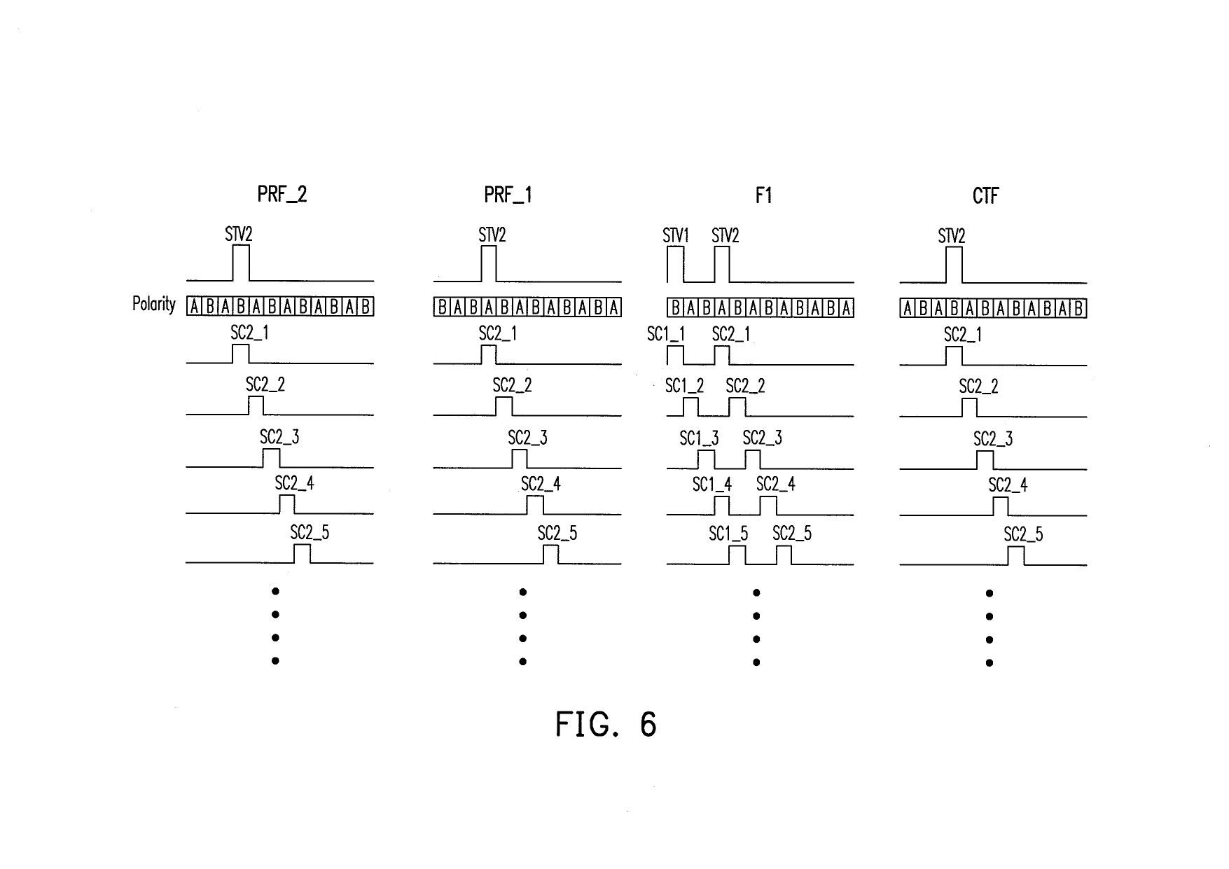

FIG. 5 is a schematic timing diagram of the start signal, the scan signal, and the polarity of the pixel voltage depicted in FIG. 1 according to the third embodiment of the invention. FIG. 6 is a schematic timing diagram of the start signal, the scan signal, and the polarity of the pixel voltage depicted in FIG. 1 according to the fourth embodiment of the invention. Referring to FIG. 1, FIG. 2, FIG. 5, and FIG. 6, in the present embodiment, the source driver 120 similarly is assumed to generate the pixel voltages VP in a row inversion driving method. Generally, after performing the polarity inversion on the polarity signal POL corresponding to the first frame F1, the polarity signal POL corresponding to the first frame F1 can be the same as the polarity signal POL corresponding to the previous frame (that is the previous frame PRF_1). Accordingly, each pixel, such as P11˜P14, P21˜P24, P31˜P34, P41˜P44, etc., is charged in the same polarity in the frame period corresponding to the first frame Fl so that the brightness corresponding to each gray level in the first fame F1 is greater than the brightness corresponding to said gray level in the previous frames PRF or the following frames CTF, which cause the image flick effect.

Based on the above descriptions, the reason of the image flick effect lies in that each pixel, such as P11˜P14, P21˜P24, P31˜P34, P41˜P44, etc., is charged in the same polarity in the frame period corresponding to the first frame F1, and thus if each pixel, such as P11˜P14, P21˜P24, P31˜P34, P41˜P44, etc., is charged in opposite polarities in the frame period corresponding to the first frame Fl, the problem of the image flick effect can be resolved. According to the present embodiment, the timing controller 110 sequentially outputs the first start signal STV1 and the second start signal STV2 to the gate driver 130 in the frame period corresponding to the first frame F1, wherein the first start signal STV1 and the second start signal STV2 are spaced by two horizontal scan periods such that each pixel, such as P11˜P14, P21˜P24, P31˜P34, P41˜P44, etc., can be charged in opposite polarities.

In addition, the operation of the LCD 100 in the frame periods corresponding to the previous frames PRF 2 and PRF_1 and the following frames CTF can be referred to the conventional LCD. In other words, the timing controller 110 outputs the first start signal STV1 or the second start signal STV2 to the gate driver 130 in the frame periods corresponding to the previous frames PRF_2 and PRF_1 and the following frames CTF, and the gate driver 130 outputs the first scan signals (such as SC1_1˜SC1_5) or the second scan signals (such as SC2_1˜SC2_5) correspondingly, which can be determined by the common knowledge in the art.

In the foregoing embodiment, the first start signal STV1 and the second start signal STV2 are spaced by two horizontal scan periods in the frame period corresponding to the first frame F1. In an alternate embodiment, each pixel, such as P11˜P14, P21˜P24, P31˜P34, P41˜P44, etc., can be charged in opposite polarities by using the received pixel voltage VP under the driving of the first scan signal SC1 and the received pixel voltage VP under the driving of the second scan signal SC2 when the first start signal STV1 and the second start signal STV2 are spaced by even numbers (e.g. 2, 4, 6 . . . ) of the horizontal scan periods in the frame period corresponding to the first frame F1.

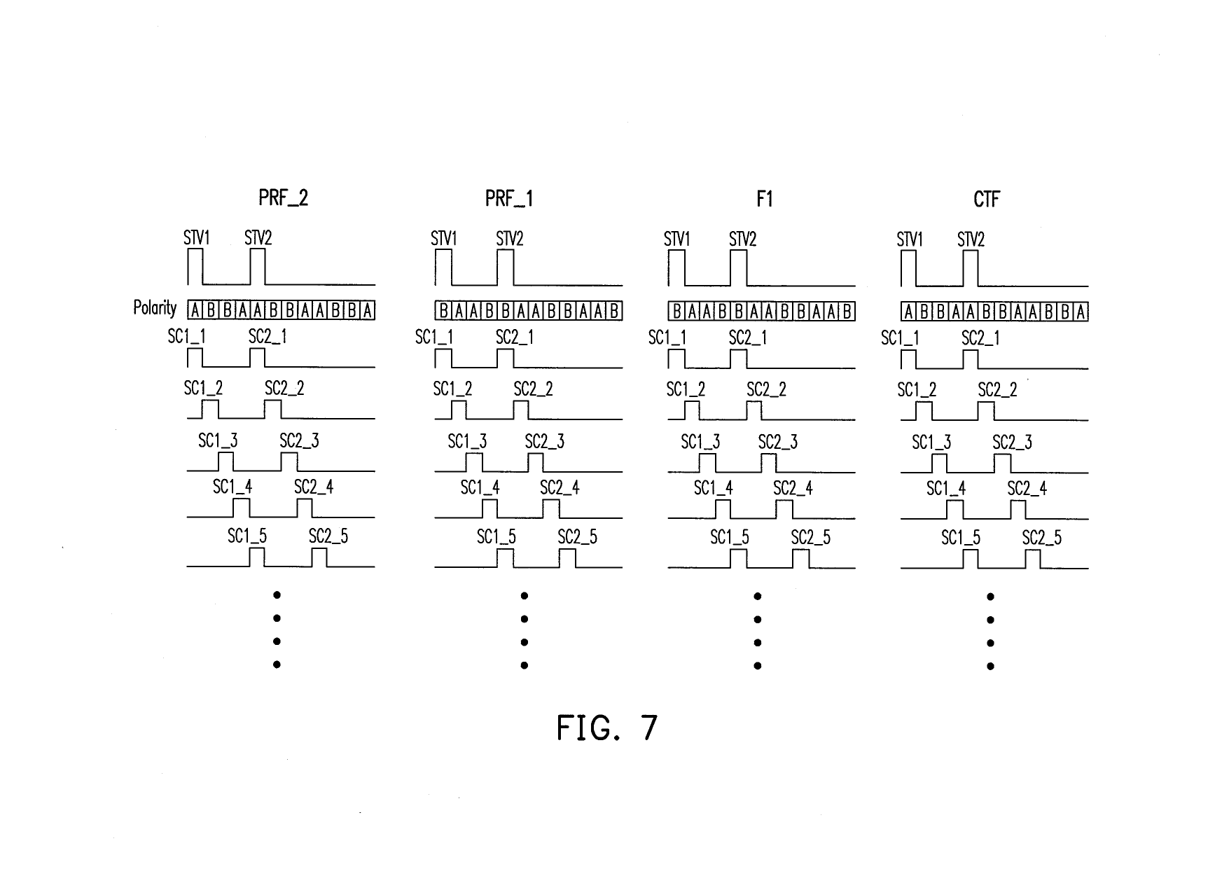

FIG. 7 is a schematic timing diagram of the start signal, the scan signal, and the polarity of the pixel voltage depicted in FIG. 1 according to the fifth embodiment of the invention. Referring to FIG. 1, FIG. 2, and FIG. 7, in the present embodiment, it is assumed that the source driver 120 generates the pixel voltages VP in a 1+n row inversion driving method, wherein n is a positive integer greater than and equivalent to 2, and herein, n is set as 2 for illustrative purposes. That is to say, in the pixel voltages VP outputted to the same data line 143 from the source driver 120, the polarities of the first, the fourth, and the fifth pixel voltages VP are one of the polarity A and the polarity B, the polarities of the second and the third pixel voltages VP are the other of the polarity A and the polarity B, and the same principle applies to the other instances. Furthermore, the polarities of the pixel voltages VP are switched corresponding to the switching of the voltage level of the polarity signal POL. Herein, the polarity A and the polarity B can respectively be one of the positive polarity and the negative polarity. Namely, when the polarity A is the positive polarity, the polarity B is the negative polarity, or when the polarity A is the negative polarity, the polarity B is the positive polarity.

Herein, in the frame periods corresponding to the previous frames PRF_2 and PRF_1, the first frame F1, and the following frames CTF, the timing controller 110 can sequentially output the first start signal STV1 and the second start signal STV2 to the gate driver 130, wherein the first start signal STV1 and the second start signal STV2 are spaced by three (i.e. 2n−1) horizontal scan periods. Therefore, the first scan signals, such as SC1_1˜SC1_5, and the corresponding second scan signals, such as SC2_1˜SC2_5, outputted by the gate driver 130 are spaced by three horizontal scan periods.

As shown in FIG. 7, the polarities of the pixel voltages VP (such as the polarity A) received by the pixels in the first row, such as P11˜P14, driven by the first scan signal SC1_1 in the LCD panel 140 are identical to the polarities of the pixel voltages VP (such as the polarity A) received by these pixels driven by the second scan signal SC2_1 in the same frame. The polarities of the pixel voltages VP (such as the polarity B) received by the pixels in the second row, such as P21˜P24, driven by the first scan signal SC1_2 in the LCD panel 140 are identical to the polarities of the pixel voltages VP (such as the polarity B) received by these pixels driven by the second scan signal SC2_2 in the same frame. The rest are all in a similar way. Therefore, the charge effect in each pixel, such as P11˜P14, P21˜P24, P31˜P34, P41˜P44, etc., can be gradually saturated in the frame periods corresponding to the previous frames PRF_2 and PRF_1, the first frame Fl, and the following frames CTF. Namely, the voltage stored in each pixel, such as P11˜P14, P21˜P24, P31˜P34, P41˜P44, etc., is substantially equivalent to the received pixel voltage VP; thereby, the image flick effect can be avoided.

In the foregoing embodiment, the first start signal STV1 and the second start signal STV2 are spaced by three (i.e. 2n−1) horizontal scan periods. In an alternate embodiment, each pixel, such as P11˜P14, P21˜P24, P31˜P34, P41˜P44, etc., can be charged in the same polarity by using the received pixel voltage VP under the driving of the first scan signal SC1 and the received pixel voltage VP under the driving of the second scan signal SC2 when the first start signal STV1 and the second start signal STV2 are spaced by 2n−1+i×2n (3, 7, 11 . . . in the present embodiment) horizontal scan periods. Herein i is a positive integer greater than or equivalent to zero.

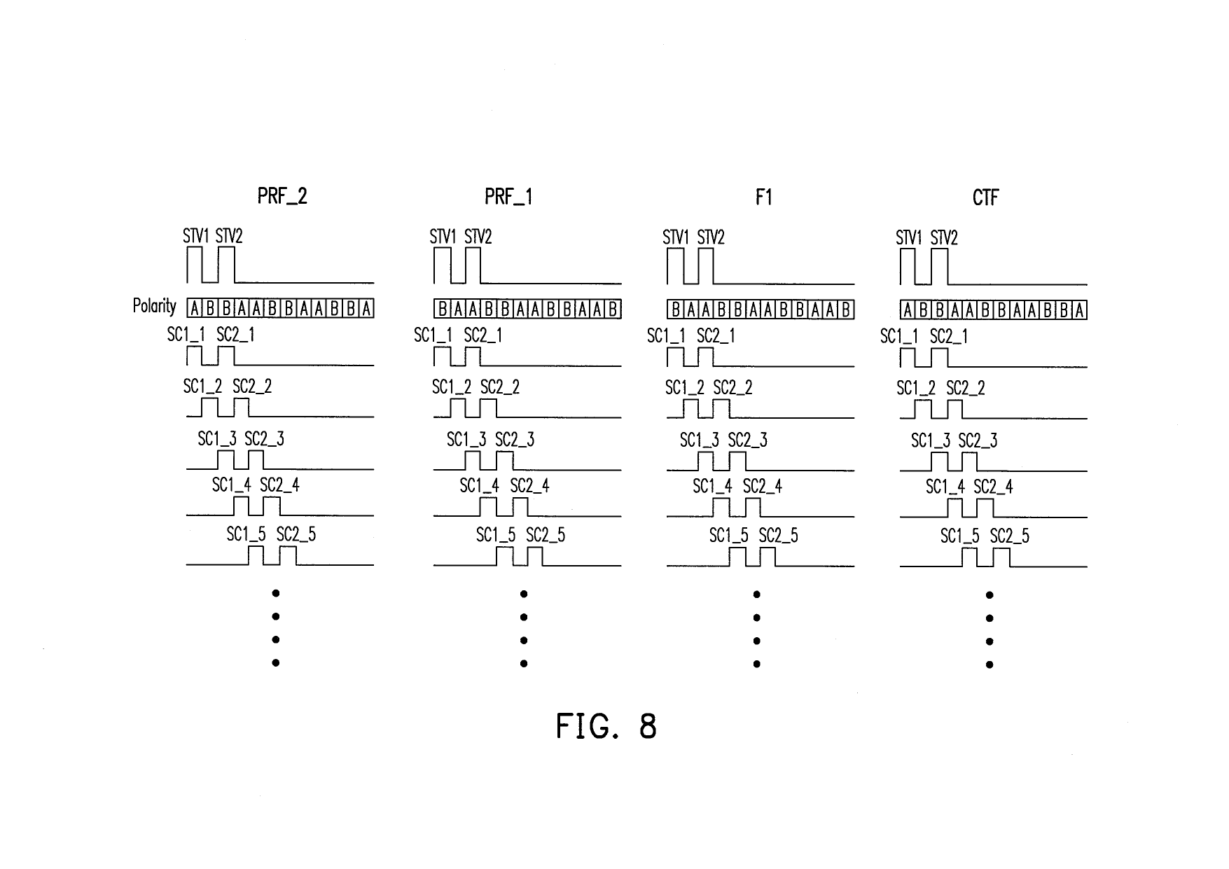

FIG. 8 is a schematic timing diagram of the start signal, the scan signal, and the polarity of the pixel voltage depicted in FIG. 1 according to the sixth embodiment of the invention. Referring to FIG. 1, FIG. 2, FIG. 7, and FIG. 8, in the present embodiment, the source driver 120 similarly is assumed to generate the pixel voltages VP in a 1+n row inversion driving method and n is exemplarily set as 2 for illustrative purposes. Herein, in the frame periods corresponding to the previous frames PRF_2 and PRF_1, the first frame F1, and the following frames CTF, the timing controller 110 can sequentially output the first start signal STV1 and the second start signal STV2 to the gate driver 130, wherein the first start signal STV1 and the second start signal STV2 are spaced by one (i.e. n−1) horizontal scan period. Therefore, the first scan signals, such as SC1_1˜SC1_5, and the corresponding second scan signals, such as SC2_1˜SC2_5, outputted by the gate driver 130 are spaced by one horizontal scan period.

As shown in FIG. 8, the polarities of the pixel voltages VP (such as the polarity A) received by the pixels in the first row, such as P11˜P14, driven by the first scan signal SC1_1 in the LCD panel 140 are opposite to the polarities of the pixel voltages VP (such as the polarity B) received by these pixels driven by the second scan signal SC2_1 in the same frame. The polarities of the pixel voltages VP (such as the polarity B) received by the pixels in the second row, such as P21˜P24, driven by the first scan signal SC1_2 in the LCD panel 140 are opposite to the polarities of the pixel voltages VP (such as the polarity A) received by these pixels driven by the second scan signal SC2_2 in the same frame. The rest are all in a similar way. Therefore, the charge effect in each pixel, such as P11˜P14, P21˜P24, P31˜P34, P41˜P44, etc., can be consistent in the frame periods corresponding to the previous frames PRF_2 and PRF_1, the first frame F1, and the following frames CTF. Namely, the voltage stored in each pixel, such as P11˜P14, P21˜P24, P31˜P34, P41˜P44, etc., for displaying the same gray level is substantially equivalent to the received pixel voltage VP corresponding to the gray level to-be displayed under the driving of the second start signal STV2; thereby, the image flick effect can be avoided.

In the foregoing embodiment, the first start signal STV1 and the second start signal STV2 are spaced by one (i.e. n−1) horizontal scan period. In an alternate embodiment, each pixel, such as P11˜P14, P21˜P24, P31˜P34, P41˜P44, etc., can be charged in opposite polarities by using the received pixel voltage VP under the driving of the first scan signal SC1 and the received pixel voltage VP under the driving of the second scan signal SC2 when the first start signal STV1 and the second start signal STV2 are spaced by n−1+i×2n (1, 5, 9 . . . in the present embodiment) horizontal scan periods. Herein, i is a positive integer greater than or equivalent to zero.

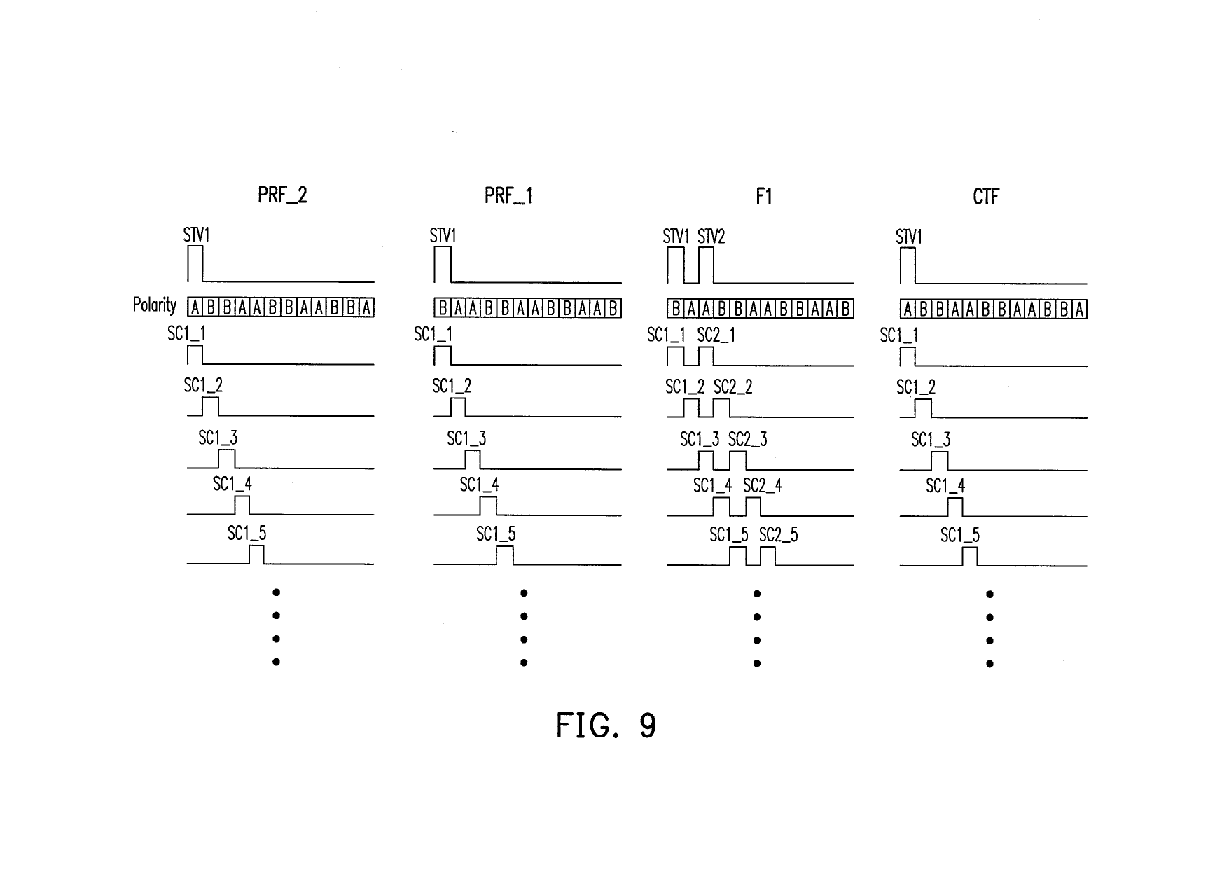

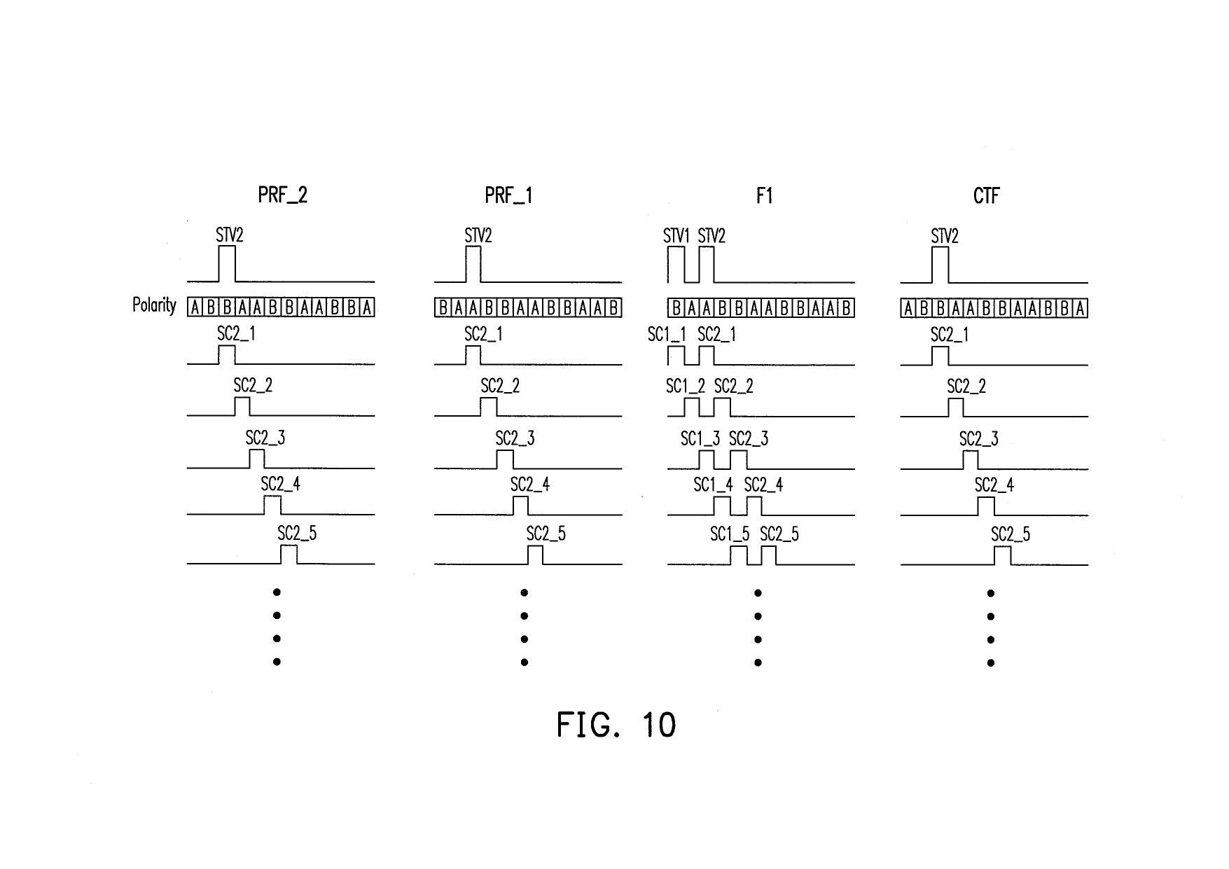

FIG. 9 is a schematic timing diagram of the start signal, the scan signal, and the polarity of the pixel voltage depicted in FIG. 1 according to the seventh embodiment of the invention. FIG. 10 is a schematic timing diagram of the start signal, the scan signal, and the polarity of the pixel voltage depicted in FIG. 1 according to the eighth embodiment of the invention. Referring to FIG. 1, FIG. 2, FIG. 9, and FIG. 10, in the present embodiment, the source driver 120 similarly is assumed to generate the pixel voltages VP in a 1+n row inversion driving method and n is exemplarily set as 2 for illustrative purpose. Based on the above descriptions, the reason of the image flick effect lies in that each pixel, such as P11˜P14, P21˜P24, P31˜P34, P41˜P44, etc., is charged in the same polarity in the frame period corresponding to the first frame F1, and thus if each pixel, such as P11˜P14, P21˜P24, P31˜P34, P41˜P44, etc., is charged in opposite polarities in the frame period corresponding to the first frame F1, the problem of the image flick effect can be resolved.

According to the present embodiment, the timing controller 110 sequentially outputs the first start signal STV1 and the second start signal STV2 to the gate driver 130 in the frame period corresponding to the first frame F1, wherein the first start signal STV1 and the second start signal STV2 are spaced by one (i.e. n−1) horizontal scan period such that each pixel, such as P11˜P14, P21˜P24, P31˜P34, P41˜P44, etc., can be charged in opposite polarities. In addition, the operation of the LCD 100 in the frame periods corresponding to the previous frames PRF_2 and PRF_1 and the following frames CTF can be referred to the conventional LCD. In other words, the timing controller 110 outputs the first start signal STV1 or the second start signal STV2 to the gate driver 130 in the frame periods corresponding to the previous frames PRF_2 and PRF_1 and the following frames CTF, and the gate driver 130 outputs the first scan signals (such as SC1_1˜SC1_5) or the second scan signals (such as SC2_1˜SC2_5) correspondingly, which can be determined by the common knowledge in the art.

In the foregoing embodiment, the first start signal STV1 and the second start signal STV2 are spaced by one (i.e. n−1) horizontal scan period in the frame period corresponding to the first frame F 1. In an alternate embodiment, each pixel, such as P11˜P14, P21˜P24, P31˜P34, P41˜P44, etc., can be charged in opposite polarities by using the received pixel voltage VP under the driving of the first scan signal SC1 and the received pixel voltage VP under the driving of the second scan signal SC2 when the first start signal STV1 and the second start signal STV2 are spaced by n−1+i×2n (1, 5, 9 . . . in the present embodiment) horizontal scan periods. Herein, i is a positive integer greater than or equivalent to zero.

In view of the above, in the LCD according to the embodiments of the invention, the timing controller sequentially outputs the first start signal and the second start signal to the gate driver in the frame periods corresponding to the previous frame, the first frame, and the following frames so that each pixel in the LCD panel is charger by the same polarity or opposite polarities. Alternately, the timing controller sequentially outputs the first start signal and the second start signal to the gate driver in the frame period corresponding to the first frame such that each pixel in the LCD panel is charged in opposite polarities. Therefore, the brightness corresponding to a plurality of gray levels in the first frame is identical to the brightness corresponding to these gray levels in the previous frames or the following frames to avoid the image flick effect.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A liquid crystal display comprising:
a liquid crystal display panel having a plurality of pixels;
a source driver coupled to the liquid crystal display panel for outputting a plurality of pixel voltages to the liquid crystal display panel;
a gate driver coupled to the liquid crystal display panel; and
a timing controller coupled to the source driver and the gate driver for performing a polarity inversion of a polarity signal outputted to the source driver; during performing the polarity inversion on the polarity signal corresponding to a first frame, the timing controller sequentially outputting a first start signal and a second start signal to the gate driver in at least a first frame period corresponding to the first frame; and the gate driver outputting a plurality of first scan signals and a plurality of second scan signals to the liquid crystal display panel according to the first start signal and the second signal, such that brightness corresponding to a plurality of gray levels in the first frame are identical to brightness of the gray levels in a plurality of previous frames and a plurality of following frames.

2. The liquid crystal display as claimed in claim 1, wherein the timing controller sequentially outputs the first start signal and the second start signal to the gate driver in the first frame period such that a polarity of the pixel voltage received by each of the pixels driven by the corresponding first scan signal is opposite to a polarity of the pixel voltage received by the each of the pixels driven by the corresponding second scan signal.

3. The liquid crystal display as claimed in claim 2, wherein the pixel voltages are generated by the source driver in a row inversion driving method.

4. The liquid crystal display as claimed in claim 3, wherein the first start signal and the second start signal are outputted continuously or spaced by even numbers of horizontal scan periods.

5. The liquid crystal display as claimed in claim 2, wherein the pixel voltages are generated by the source driver in a 1+n row inversion driving method while n is a positive integer greater than or equivalent to 2.

6. The liquid crystal display as claimed in claim 5, wherein the first start signal and the second start signal are spaced by n−1+i×2n horizontal scan periods while i is a positive integer greater than or equivalent to 0.

7. The liquid crystal display as claimed in claim 2, wherein the timing controller outputs the first start signal to the gate driver in a plurality of previous frame periods corresponding to the previous frames and a plurality of following frame period corresponding to the following frames.

8. The liquid crystal display as claimed in claim 2, wherein the timing controller outputs the second start signal to the gate driver in a plurality of previous frame periods corresponding to the previous frames and a plurality of following frame period corresponding to the following frames.

9. The liquid crystal display as claimed in claim 2, wherein the timing controller outputs the first start signal and the second start signal to the gate driver in a plurality of previous frame periods corresponding to the previous frames and a plurality of following frame period corresponding to the following frames.

10. The liquid crystal display as claimed in claim 1, wherein the timing controller sequentially outputs the first start signal and the second start signal to the gate driver in the first frame period, a plurality of previous frame periods corresponding to the previous frames and a plurality of following frame period corresponding to the following frames, such that a polarity of the pixel voltage received by each of the pixels driven by the corresponding first scan signal is identical to a polarity of the pixel voltage received by the each of the pixels driven by the corresponding second scan signal.

11. The liquid crystal display as claimed in claim 10, wherein the pixel voltages are generated by the source driver in a row inversion driving method.

12. The liquid crystal display as claimed in claim 11, wherein the first start signal and the second start signal are spaced by odd numbers of horizontal scan periods.

13. The liquid crystal display as claimed in claim 10, wherein the pixel voltages are generated by the source driver in a 1+n row inversion driving method while n is a positive integer greater or equivalent to 2.

14. The liquid crystal display as claimed in claim 13, wherein the first start signal and the second start signal are spaced by 2n−1+i×2n horizontal scan periods while i is a positive integer greater than or equivalent to 0.
